(19) United States
(12) Patent Application Publication
(10) Pub. No.: US 2009/0059184 A1
(43) Pub. Date: Mar. 5, 2009

(54) PROJECTOR

(75) Inventor: SHIH-CHIEH CHOU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/033,215

(22) Filed: Feb. 19, 2008

(30) Foreign Application Priority Data
Aug. 31, 2007 (CN) 200710201551.4

(51) Int. Cl. G03B 21/20

(52) U.S. Cl. 353/85

(57) ABSTRACT

A projector includes a light source for emitting light, a color wheel for filtering the light emitted from the light source, a converging module for converging the filtered light, a light-modulating device for modulating the light emitted from the light source, a lens module for projecting the light modulated by the light-modulating device; and a contrast-adjusting device. The contrast-adjusting device is positioned in a light path associated with the light source. The contrast-adjusting device includes a liquid crystal panel and a driving element. The liquid crystal panel is inserted into the light path associated with light source inside the lens module, and is driven by the driving element to tilt relative to light incident thereon from the light source so that contrast of the light output from the liquid crystal panel changes.

### BACKGROUND

1. Field of the Invention

The present invention relates to projecting technology, and particularly, to a projector.

2. Description of Related Art

Projectors are widely used in different places, such as meeting rooms, plazas, theatres, etc. To enhance suitability of the projector in different environments, contrast of a projected image produced by the projector can, typically, be adjusted by use of an aperture. The aperture generally includes a plurality of shutter blades and a mechanical structure for adjusting a combination of the plurality of shutter blades. However, the aperture is complicated and therefore costly.

What is needed, therefore, is to provide a projector with a simple contrast-adjusting device.

### SUMMARY

The present invention relates to a projector. The projector includes a light source for emitting light, a color wheel for filtering the light emitted from the light source, a converging module for converging the filtered light, a light-modulating device for modulating the light emitted from the light source, a lens module for projecting the light modulated by the light-modulating device; and a contrast-adjusting device. The contrast-adjusting device is positioned in a light path associated with the light source. The contrast-adjusting device includes a liquid crystal panel and a driving element. The liquid crystal panel is inserted into the light path associated with light source inside the lens module, and is driven by the driving element to tilt relative to light incident thereon from the light source so that contrast of the light output from the liquid crystal panel changes.

Other advantages and novel features of the present invention will become more apparent from the following detailed description of present embodiments when taken in conjunction with the accompanying drawings, in which:

### BRIEF DESCRIPTION OF THE DRAWINGS

FIG. 1 is a schematic view of a projector, in accordance with a present embodiment;

FIG. 2 shows light going through a liquid crystal panel in the projector of FIG. 1; and

FIG. 3 is a diagram showing a viewing-angle characteristic curve of the liquid crystal panel of FIG. 2.

### DETAILED DESCRIPTION OF THE EMBODIMENTS

Reference will now be made to the figures to describe at least one present embodiment in detail.

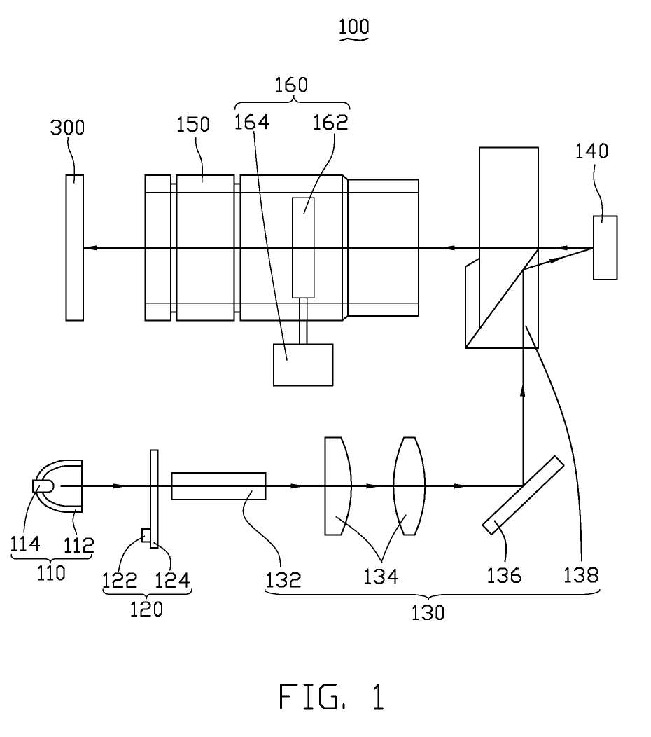

Referring to FIG. 1, a projector 100, in accordance with a present embodiment, is shown. As an example, the projector in the present embodiment is a digital-light-processing (DLP) projector. The projector 100 includes a light source 110, a color wheel 120, a converging module 130, a light-modulating device 140, a lens module 150, and a contrast-adjusting device 160. In the present embodiment, the light-modulating device 140 is a digital micro-mirror device (DMD) 140.

The light source 110 includes a cover 112 and a light emitting portion 114 received in the cover 112. Beneficially, the cover 112 is an elliptical-shaped cover, and the light emitting portion 114 is positioned at a focal point of the cover 112. Generally, the light emitting portion 114 is a metal halide lamp, a high-voltage mercury lamp, or a white light emitting diode for emitting white light.

The color wheel 120 includes a motor 122 and a color filter 124. The motor 122 drives the color filter 124 to rotate in the path of light from the light source 110, creating, for example, red light, green light, and blue light, which is then transmitted to the converging module 130.

The converging module 130 guides light from the color wheel 120 to the DMD 140. The converging module 130 includes an integrator 132, a condenser 134, a reflective mirror 136, and a total-internal-reflective prism 138. The integrator 132 can be a solid integrator or a hollow integrator. The integrator 132 is capable of transforming radial light to parallel light suitable for being incident on the DMD 140. The condenser 134 converges the light emitted from the light source 110 to reduce loss of light energy. The light converged by the condenser 134 is reflected by the reflective mirror 136 to the total-internal-reflective prism 138, and then the light is reflected by the total-internal-reflective prism 138 towards the DMD 140.

The light is modulated by the DMD 140 then transmitted through the total-internal-reflective prism 138, and is projected by the lens module 150 to produce an image on a screen 300.

In this embodiment, the contrast-adjusting device 160 includes a liquid crystal (LC) panel 162 inserted into the light path associated with light source 110 inside the lens module 150, and a driving device 164 linking with the LC panel 162. The LC panel 162 is driven by the driving device 164 to tilt so as to adjust an angle of the light incident on the LC panel 162. A voltage may be applied to the driving device 164 by a user operating the projector to tilt the LC panel 162.

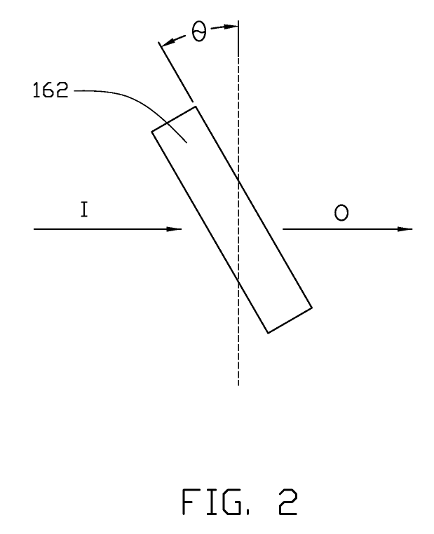

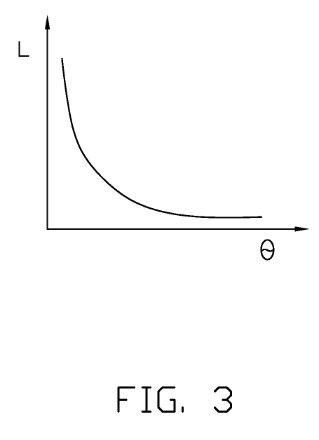

Referring to FIG. 2, an incident light into the LC panel 162 is designated as I, and an outgoing light from the LC panel 162 is designated as O. FIG. 3 is a diagram showing a viewing-angle characteristic curve of the LC panel 162. A horizontal axis of the diagram is an inclined angle θ of the LC panel 162 relative to a vertical direction. A vertical axis of the diagram is an intensity L of the outgoing light O. The intensity L of the outgoing light O becomes greater when the inclined angle θ of the LC panel 162 becomes smaller, as shown in FIG. 3. Therefore, contrast of an image produced by the projector by adjusting intensity L of the outgoing light O by adjusting the inclined angle θ of the LC panel 162, with the driving element 164, which includes a tilt motor (not shown) to tilt the LC panel 162.

It is to be understood that the LC panel 162 may be placed at other positions in the light path associated with the light source 110.

By using the contrast-adjusting device 160 with an LC panel 162, and a driving element 164 in the projector 100, it is a simple matter to adjust contrast of an image produced by the projector 110 by simply adjusting the incident angle of the light to the LC panel 162.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A projector comprising:
a light source for emitting light;
a color wheel for filtering the light emitted from the light source;
a converging module for converging the filtered light;
a light-modulating device for modulating the light emitted from the light source;
a lens module for projecting the light modulated by the light-modulating device; and
a contrast-adjusting device being positioned in a light path associated with the light source, the contrast-adjusting device including a liquid crystal panel and a driving element, the liquid crystal panel being inserted into the light path associated with light source inside the lens module, and being driven by the driving element to tilt relative to light incident thereon from the light source so that intensity of the light output from the liquid crystal panel changes.

2. The projector as claimed in claim 1, wherein the light source comprises a cover and a light emitting portion received in the cover.

3. The projector as claimed in claim 2, wherein the cover is an elliptical-shaped cover, and the light emitting portion is positioned at a focal point of the cover.

4. The projector as claimed in claim 3, wherein the light emitting portion is a metal halide lamp.

5. The projector as claimed in claim 3, wherein the light emitting portion is a high-voltage mercury lamp.

6. The projector as claimed in claim 3, wherein the light emitting portion is a white light emitting diode for emitting white light.

7. The projector as claimed in claim 1, wherein the color wheel comprises a motor and a color filter, the motor driving the color filter to rotate.

8. The projector as claimed in claim 1, wherein the converging module comprises an integrator, a condenser, a reflective mirror, and a total-internal-reflective prism arranged in order along the light path associated with the light source.

9. The projector as claimed in claim 1, wherein the light-modulating device is a digital micro-mirror device.
